(19) United States
(12) Patent Application Publication
(10) Pub. No.: US 2006/0240250 A1
(43) Pub. Date: Oct. 26, 2006

(54) Releasable, erasable patch and method of manufacture thereof

(76) Inventor: Brian Starzynski, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/408,144

(22) Filed: Apr. 20, 2006

Related U.S. Application Data
(60) Provisional application No. 60/673,027, filed on Apr. 20, 2005.

(51) Int. Cl. B32B 38/14; B32B 37/00; B32B 38/04

(52) U.S. Cl. 428/343; 156/250; 156/277; 156/278; 428/352

(57) ABSTRACT

A patch comprises a cut-out shape including a front face and a back face; a top coat formed on the front face of the cut-out shape; and a releasable adhesive coating rolled on the back face of the cut-out shape. A method of manufacturing the patch comprises the steps of cutting a shape having a front face and a back face from a first material; printing an indicia on the front face of the shape; applying a second material to the front face of the shape; and applying a releasable adhesive to the back face of the shape.

### CROSS REFERENCE TO RELATED APPLICATIONS

This application claims the benefit of United States Provisional Patent Application No. 60/673,027 entitled “The Scratch Pad” filed Apr. 20, 2005, which is hereby incorporated by reference in its entirety.

### BACKGROUND OF THE INVENTION

1. Field of the Invention

The present invention relates, in general, to a patch and, more specifically, to patch with an erasable writing surface securable via a releasable adhesive.

2. Description of Related Art

Current identification tags or patches typically comprise a piece of paper with an adhesive backing. The tags may include blank lines for the name, address and telephone number of a person, graphics, or may be blank. Such tags are generally meant to be written upon only once. If the user writes on the tag with a felt or ball point pen, the writing cannot be removed without damaging the tag. Even if the user writes on the tag with a pencil, erasing the names will generally damage any graphics and indicia on the tag, as well as the tag itself. As a result, such tags are usually thrown away after one usage.

Current identification tags also suffer frequent attachment failure. Due to the fact that the tags are designed to be for only one usage of short duration, manufacturers generally make the tags from relatively insubstantial materials, such as heavy paper. It is therefore not unusual to find in actual use that the tags have become separated from the user.

Erasable labels are known in the art. U.S. Pat. No. 4,757,901 to Woods (1988); U.S. Pat. No. 5,024,332 to Stachler (1991); and U.S. Pat. No. 5,040,296 to Yerger (1991) disclose typical erasable labels. Such labels are generally intended for videocassettes, floppy disks, and the like. Although they can be written upon and erased without damage to the label, they are not meant to be transferred from one item to another. In fact, they teach the use of adhesive coatings on the backside for permanent attachment to one item.

Accordingly, a need exists for an erasable patch or tag with a releasable adhesive backing that can be used multiple times. A further need exists for a patch that can be secured to a user's arm or leg and includes an erasable writing surface thereby allowing the user to take quick measurements, directions or details when paper is not available or inconvenient to hold.

### SUMMARY OF THE INVENTION

The present invention is a patch with an erasable writing surface secured via a releasable adhesive. The patch comprises a cut-out shape including a front face and a back face; a top coat formed on the front face of the cut-out shape; and an adhesive coating rolled on the back face of the cut-out shape. The cut-out shape may be fabricated from one of a non-porous oil-based vinyl and a printing film polypropylene and may have an indicia printed thereon. The indicia may be a logo, a name, lines, or any combination thereof. The indicia may be printed on the cut-out shape using a laser printer, an ink-jet printer, screen printing techniques, spraying, roller-coating or any combination thereof. The top coat may be a polymer two-part epoxy coating, and contains a flexible first coat and a second coat comprising a hardening agent. The adhesive is water-based and releasable.

The present invention is also directed to a patch comprising a shape comprising a front face and a rear face, a top coat formed on the front face of the shape and a releasable, water-based adhesive coating rolled on the back face of the shape. The shape is cut-out from a sheet of one of a non-porous oil-based vinyl and a printing film polypropylene. The top coat comprises a flexible first coat and a hardening agent. In use, a user a) applies the patch to a surface, b) writes on the top coat, c) erases the top coat, d) removes the patch from the surface and e) reuses the patch by repeating steps a) through d). The surface may be at least one of an arm, a leg, a torso, a wall, a floor, a ceiling, a table, a chair and a counter.

The present invention is also a method of manufacturing a patch. The method includes the steps of cutting a shape having a front face and a back face from a first material; printing an indicia on the front face of the shape using a laser flex printing technique; applying a second material to the front face of the shape; and applying an adhesive to the back face of the shape. The method may further include the steps of applying a backing to the adhesive on the back face of the shape and writing on the second material using a grease pencil. The first material may be either a non-porous oil-based vinyl or a printing film polypropylene. The second material may be a polymer two-part epoxy coating. The backing may be a non-porous wax paper.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a top elevational view of a patch in accordance with the present invention;

FIG. 2 is a bottom elevational view of the patch in accordance with the present invention;

FIG. 3 is an exploded perspective view of the patch in accordance with the present invention; and

FIG. 4 is a front plan view of a user using the patch in accordance with the present invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

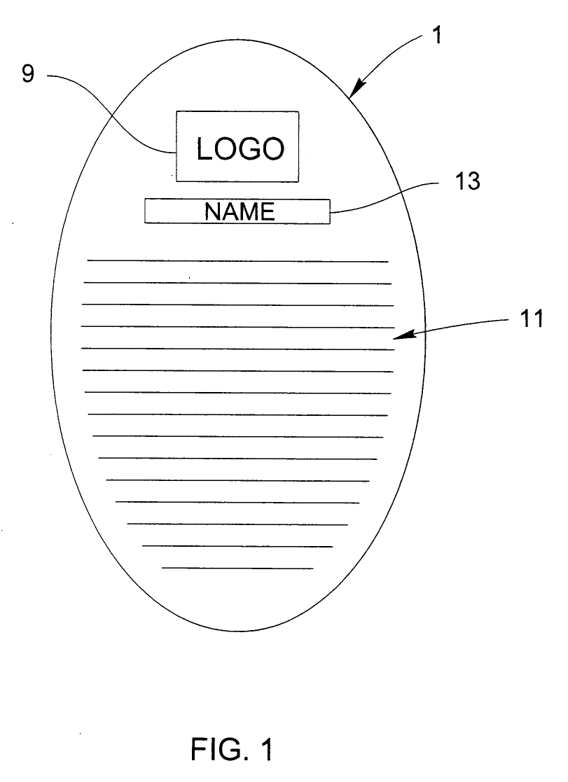

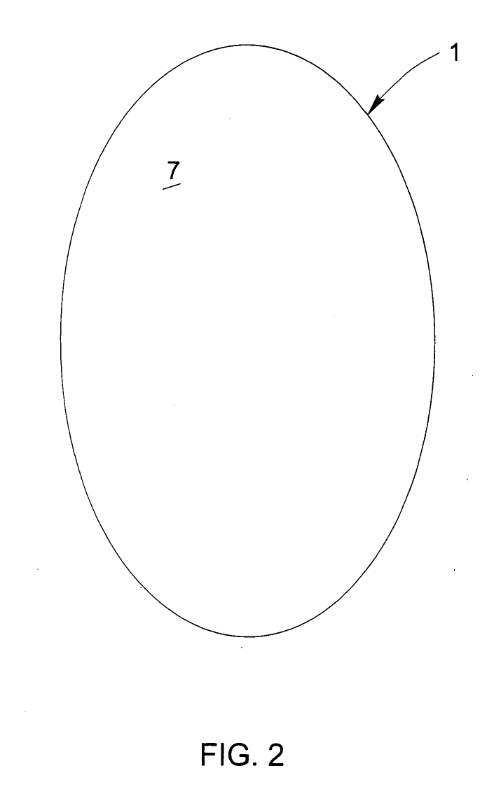

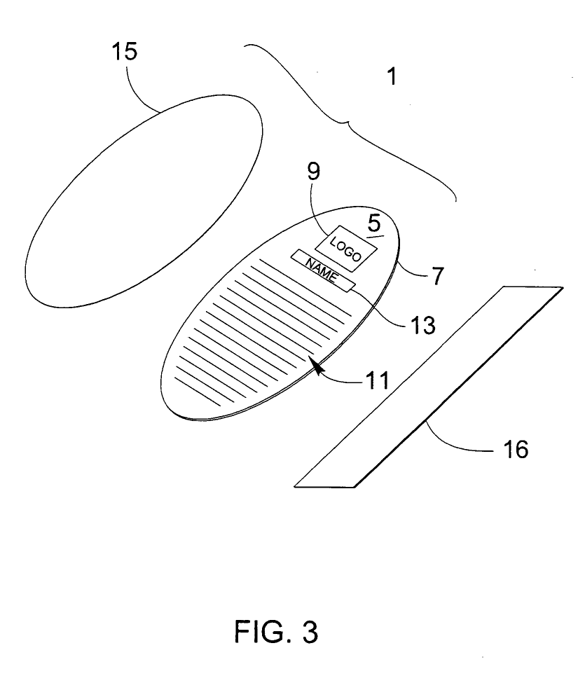

With reference to FIGS. 1-3, a patch, denoted generally as 1, includes a cut-out shape 3 with a front face 5 and a back face 7. Cut-out shape 3 is cut from a non-porous oil based vinyl, printing film polypropylene or the like and can be a variety of different colors. While the figures illustrate that cut-out shape 3 is an oval, any shape, such as squares, rectangles, triangles, etc., may be utilized. Furthermore, cut-out shape may be of any suitable thickness, for example about 1 mm. Indicia such as a logo 9, writing lines 11, a name 13 or the like may be printed on the front face 5 of the cut-out shape using any appropriate printing technique. Such printing techniques include, but are not limited to, a laser printing, an ink-jet printing, screen printing techniques, spraying, roller-coating or any combination thereof.

Patch 1 further includes a top coat 15. Top coat 15 comprises a polymer, two-part epoxy coating or the like. This coating includes a flexible first coat and a second coat that contains a hardening agent. Top coat 15 allows patch 1 to have an erasable writing surface. The user can write on top coat 15 with a grease pencil, a dry erase marker or the like.

Patch 1 further includes an adhesive layer applied to back face 7 of cut-out shape 3. The adhesive used is water-based and releasable. This allows a user to attach the patch to his arm or leg to take measurements, directions or notes when paper is not readily available or convenient to hold. A backing paper 16 such as a non-porous wax paper is attached to the adhesive layer when patch 1 is not in use.

The present invention is also drawn to a method of manufacturing a patch. First, a shape having a front face and a back face is cut from a first material. The first material is a non-porous oil based vinyl, printing film polypropylene or the like. Any appropriate cutting method may be used to cut the shape such as scissors, a cutting press or the like. Next, an indicia is printed on the front face of the shape using any appropriate printing technique. Such printing techniques include, but are not limited to, a laser printing, an ink-jet printing, screen printing techniques, spraying, roller-coating or any combination thereof. Subsequently, a second material is applied to the front face of the shape. The second material is a polymer, two-part epoxy coating or the like. The polymer, two-part epoxy coating includes a flexible first coat and a second coat that contains a hardening agent. Finally, a releasable adhesive is applied to the back face of the shape. Desirably, the releasable adhesive is a water-based adhesive thereby preventing damage to a user's clothing when the user applies the patch to his/her arm or leg. Additionally, the method includes the step of attaching a backing paper, such as, but not limited to, a non-porous wax paper, to the adhesive layer when the patch is not in use.

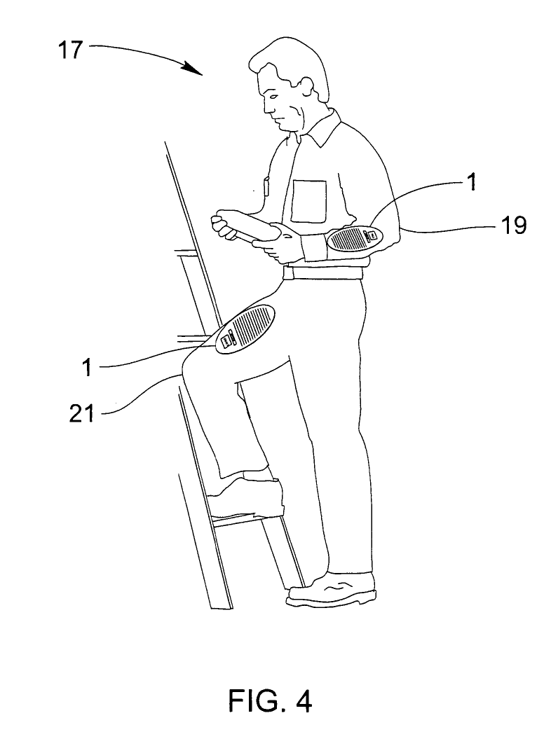

With reference to FIG. 4, the present invention is envisioned being used in situations where paper is not available or difficult to hold. The user can remove the backing paper and apply patch 1 to a surface. The surface may be, but is not limited to, the user's arm, leg or torso, a wall, a floor, a ceiling, a chair, a table or a counter. As illustrated in FIG. 4, a user 17 may apply a patch 1 to his arm 19 or leg 21. The user can then take quick measurements or write directions. Since top coat 15 provides an erasable, writable surface, the user can erase any measurements or directions written thereon and reuse the patch. Furthermore, the releaseable adhesive backing allows the user to remove patch 1 from the surface (e.g., his/her arm 19 or leg 21) when he/she is finished using patch 1, reattach backing paper 16 and reuse the patch 1 at a later time. Patch 1 would be particularly useful for construction workers, contractors, pilots and waiters or waitresses.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A patch comprising:
a cut-out shape including a front face and a back face;
a top coat formed on the front face of the cut-out shape; and
a releasable adhesive coating rolled on the back face of the cut-out shape.

2. The patch of claim 1, wherein the cut-out shape is made from one of a non-porous oil-based vinyl and a printing film polypropylene.

3. The patch of claim 1, wherein the cut-out shape has an indicia printed thereon.

4. The patch of claim 3, wherein the indicia is a logo, a name lines or any combination thereof.

5. The patch of claim 3, wherein the indicia is printed on the cut-out shape using laser printing, ink-jet printing, screen printing, spraying, roller-coating or any combination thereof.

6. The patch of claim 1, wherein the top coat comprises a polymer two-part epoxy coating.

7. The patch of claim 6, wherein the polymer two-part epoxy coating comprises a flexible first coat and a second coat comprising a hardening agent.

8. The patch of claim 1, wherein the adhesive is water-based.

9. A patch comprising:
a shape cut-out from a sheet of one of a non-porous oil-based vinyl and a printing film polypropylene, the shape comprising a front face and a rear face;
a top coat formed on the front face of the shape, the top coat comprising a flexible first coat and a hardening agent; and
a releasable, water-based adhesive coating rolled on the back face of the shape,
wherein a user a) applies the patch to a surface, b) writes on the top coat, c) erases the top coat, d) removes the patch from the surface and e) reuses the patch by repeating steps a) through d).

9. The patch of claim 8, wherein the shape has an indicia printed thereon.

10. The patch of claim 9, wherein the indicia is a logo, a name, lines or any combination thereof.

11. The patch of claim 9, wherein the indicia is printed on the cut-out shape using laser printing, ink-jet printing, screen printing, spraying, roller-coating or any combination thereof.

12. The patch of claim 8, wherein the surface is at least one of an arm, a leg, a torso, a wall, a floor, a ceiling, a table, a chair and a counter.

13. A method of manufacturing a patch comprising the steps of:
cutting a shape having a front face and a rear face from a first material;
printing an indicia on the front face of the shape;
applying a second material to the front face of the shape;
applying a releasable adhesive to the back face of the shape.

14. The method of claim 13, wherein the first material is one of a non-porous oil-based vinyl and a printing film polypropylene.

15. The method of claim 13, wherein the second material is a polymer two-part epoxy coating.

16. The method of claim 15, wherein the polymer two-part epoxy coating comprises a flexible first coat and a second coat comprising a hardening agent.

17. The method of claim 13, wherein the adhesive is water-based.

18. The method of claim 13, further comprising the step of applying a backing to the adhesive on the back face of the shape.

19. The method of claim 18, wherein the backing is a non-porous wax paper.

20. The method of claim 13, further comprising the step of writing on the second material using a grease pencil.
